(19) United States
(12) Patent Application Publication
(10) Pub. No.: US 2011/0139542 A1
(43) Pub. Date: Jun. 16, 2011

(54) ACOUSTIC SHIELD

(75) Inventor: Mark Borroni, Victoria (AU)

(73) Assignee: Bellmax Acoustic Pty Ltd, Surrey Hills, Victoria (AU)

(21) Appl. No.: 12/301,912

(22) PCT Filed: May 21, 2007
(86) PCT No.: PCT/AU2007/000698

§ 371 Date: Dec. 1, 2008

(30) Foreign Application Priority Data
May 23, 2006 (AU) 2006902776

(51) Int. Cl. G10K 11/168; E04B 1/82

(52) U.S. Cl. 181/290

(57) ABSTRACT

A multilayered acoustic shield (1) for mounting to a panel of a vehicle, the shield (1) including an outer portion and an inner portion, the outer portion including a support layer (5) having apertures (6) therein, the inner portion including a sound-absorbing layer (9) and a vibration-dampening layer (11), wherein the shield (1) is fastenable to the panel of the vehicle such that at least a portion of the dampening layer (11) engages the panel with the sound-absorbing layer (9) being compressed between the outer portion and the dampening layer (11), to thereby reduce the transmission of noise into a cabin of the vehicle.

### FIELD OF THE INVENTION

The present invention relates to an acoustic shield. More particularly, the invention relates to a multilayered acoustic shield. As the acoustic shield is particularly suited for mounting to a vehicle, in particular the transmission tunnel of an automobile, it will be convenient to describe the invention in relation to that example application. It should however be understood that the invention is equally suitable for mounting to other parts of a vehicle—for example, a firewall in the engine bay of the vehicle. Further it should be understood that the invention is also intended for other applications besides vehicles.

### BACKGROUND OF THE INVENTION

Vehicles such as automobiles, trains, buses, trucks, boats and the like typically produce significant levels of undesirable vibration and sound, otherwise known as noise. The cabin of a vehicle, where the vehicle operator and/or passengers are located during transit, is subjected to varying degrees of external noise. The external noise usually originates from a number sources in the vehicle, for example, the engine, transmission, drivetrain, exhaust, suspension, steering system and wheels, and from other nearby vehicles. The noise travels through the vehicle in the air and/or structurally through the vehicle's body. Increasingly, there is an expectation that the cabin of a vehicle should be quieter.

In addition, regulatory bodies are increasingly demanding a reduction in the emission of noise by vehicles, particularly automobiles, into the surrounding environment.

In the past, attempts have been made to reduce the impact of external airborne noise on the cabin of vehicles by placing a shield of acoustic material around the perimeter of the cabin. In this respect it is known that the most effective way of reducing airborne noise is to intercept it before it enters the cabin. For this reason attempts have been made in the past to use acoustic shielding externally of the vehicle's cabin. However, this approach has not always proved to be successful due to space constraints and harsh environmental conditions which can be experienced externally of the cabin, for example underneath the vehicle's floorpan. For this reason, virtually all modern day vehicles have internally of the cabin some form of acoustic material lining the firewall and the floorpan of the cabin underneath a layer of floor covering such as carpet. Shielding externally of the cabin is generally used as a supplement to internal acoustic shielding. A problem with using acoustic shielding inside the vehicle's cabin is that the shielding takes up interior space as it needs to be particularly thick to provide a similar level of performance to external shielding.

In general, acoustic materials can be categorised according to their affect upon sounds. A sound insulating material is an acoustic material which can intercept and reflect a sound wave which is propagating through air, as opposed to a solid material. Sound insulators are usually materials which have a high surface density, for example bricks and concrete.

A sound absorbing material is an acoustic material which is porous such that an airborne sound wave can propagate into the material with the mechanical or vibrational energy of the sound wave being reduced by converting the energy into thermal energy due to friction within the material. Examples of sound absorbing materials include open cell foamed plastics, fibreglass, blankets and the like.

A vibration dampening material is an acoustic material which can intercept a sound wave propagating through a solid material, as opposed to air. The mechanical or vibrational energy of the sound wave is reduced by converting the energy of the sound into thermal energy due to deformation of the dampening material. Vibration dampening materials are typically applied directly to the surface of the solid material. Examples of vibration dampening materials include rubber, plastic, bituminous or loaded Ethylene Vinyl Acetate (EVA) materials and the like.

The body structure of vehicles is increasingly becoming stiffer in order to improve their ability to withstand the impact associated with a major collision. Unfortunately, as the stiffness of a vehicle's body increases so to does the transmission of noise and vibration through the body. In order to minimise the transmission of vibration, sheets of vibration dampening material are typically placed on top of the floorpan of a vehicle in areas where vibrations are most prevalent. In this regard the sheets of vibration dampening material are normally applied to the floorpan before the vehicle body is painted. When the body is painted and subjected to high temperatures during curing of the paint the dampening material then adheres to the floorpan. A problem with applying vibration dampening material this way is that molten dampening material can flow on vertical or inclined surfaces and thereby gather in certain areas which results in the material having an uneven thickness over the floorpan.

Attempts have also been made in the past to further reduce the impact of external noise on the cabin of vehicles by additionally locating acoustic material on the fire wall in the engine bay and underneath the vehicle on the floorpan of the cabin, for example on the underside of the transmission tunnel. However, the engine bay and area underneath the floorpan of the cabin are harsh environments for acoustic material as significant heat is generated by the engine, transmission and exhaust system in these areas. The exterior of an exhaust system's muffler and connecting pipes can typically reach temperatures of 500° C. Such extreme heat can result in the floorpan reaching temperatures in excess of 220° C. Further, these areas, particularly the underside of the floorpan, are usually subjected to water, dirt, rocks and other debris. For these reasons, heat shields mounted in such locations have in the past included an outer protective metallic cover and been generally mounted to have minimal surface contact with the floorpan to reduce heat transfer. In this regard, minimal surface contact is normally achieved by spacing the shield such that contact with the floorpan is only made via the shield's fasteners. This type of arrangement helps to protect the floorpan and inner layers of the shield from excessive heat. Unfortunately, a problem with this type of arrangement is that the shield may be excited by structural vibrations within the floorpan which can result in the shield generating noise in excess of 3 dB. A further problem with this type of arrangement is that the protective metal cover can have a detrimental impact upon the acoustic performance of the shield. In this respect, the metal cover has a tendency to reflect noise incident on the shield rather than allow noise to penetrate and thereby interact with the inner layers of the shield.

Accordingly, it would be desirable to provide an acoustic shield which overcomes or ameliorates at least one of the above mentioned problems with the prior art.

Any discussion of documents, devices, acts or knowledge in this specification is included to explain the context of the invention. It should not be taken as an admission that any of the material formed part of the prior art base or the common general knowledge in the relevant art in Australia or any other country on or before the priority date of the claims herein.

### SUMMARY OF THE INVENTION

In accordance with a first aspect of the present invention there is provided a multilayered acoustic shield for mounting to a panel of a vehicle. The shield includes an outer portion and an inner portion. The outer portion includes a support layer having apertures therein. The inner portion includes a sound absorbing layer and vibration dampening layer. The shield is fastenable to the panel of the vehicle such that at least a portion of the dampening layer engages the panel with the sound absorbing layer being compressed between the outer portion and the dampening layer, to thereby reduce the transmission of noise into a cabin of the vehicle.

In an embodiment of the invention, the outer portion further includes a metallic foil located between the support layer and the sound absorbing layer.

Further, the metallic foil may have perforations therein and the vibration dampening layer can preferably be made of a viscoelastic material which is moulded to conform with a curvature of the panel.

In a preferred embodiment the support layer is a sheet of rigid material which includes a plurality of indentations therein. At least one of the indentations can include an aperture therein and sidewalls which converge towards the aperture. The sidewalls may provide a continuous curved surface extending around the aperture.

In a particularly preferred embodiment a multiple number of the indentations each include an aperture and sidewalls which converge towards their respective aperture. In use a multiple number of the apertures can abut with an adjoining layer of the acoustic shield to thereby guide sound waves incident on the sidewalls through the apertures towards the adjoining layer. In this respect, the adjoining layer could be the metallic foil or alternatively the sound-absorbing layer. The sidewalls of adjoining indentations may also converge towards one another with a cavity being formed between the sidewalls of adjoining indentations and the adjoining layer of the acoustic shield. An opening to each cavity may be provided at an intersection of the sidewalls of adjoining indentations to define each cavity as a Helmholtz resonator.

In accordance with another aspect of the present invention there is provided a multilayered acoustic shield for mounting to an underside of a transmission tunnel in a vehicle floorpan. The shield includes an outer portion and an inner portion. The outer portion includes a support layer having apertures therein. The inner portion includes a sound absorbing layer and a vibration dampening layer, wherein the shield is fastenable to the vehicle floorpan such that at least a portion of the dampening layer engages with the underside of the transmission tunnel with the sound absorbing layer being compressed between the outer portion and the dampening layer, to thereby reduce the transmission of noise into a cabin of the vehicle.

The dampening layer is preferably made of a viscoelastic material which is moulded to conform with a curvature of the panel, for example the transmission tunnel. The sound absorbing layer in combination with the vibration dampening layer enables the present invention to provide an optimal degree of sound absorption. In this regard the vibration dampening material not only dampens the vibrational energy of sound waves within the transmission tunnel by directly contacting the transmission tunnel but also reduces the transmission of sound into the cabin of the vehicle due to an outer surface of the dampening material acting as a reflective surface to assist to deflect some of the airborne sound waves back into the sound absorbing layer. In addition, the vibration dampening material is able to absorb some of the airborne sound waves, which impact upon the outer surface, as mechanical energy.

### BRIEF DESCRIPTION OF THE DRAWINGS

Further benefits and advantages of the present invention will become apparent from the following description of preferred embodiments of the invention. The following description should not be considered as limiting any of the statements in the previous section. Preferred embodiments will be described with reference to the following figures in which:

FIG. 1 is a cross-sectional view of a transmission tunnel in a vehicle with a multilayered acoustic shield attached thereto, the multilayered acoustic shield having a support layer with apertures therein, according to an embodiment of the invention;

FIG. 2 is a cross-sectional view of a multilayered acoustic shield without a moulded groove in the dampening layer, according to another embodiment of the invention; and

FIG. 3 is a cross-sectional view of a vehicle floorpan with a multilayered acoustic shield attached thereto, the multilayered acoustic shield having a support layer with apertures therein, in accordance with another embodiment of the invention;

FIG. 4 is a perspective view of a first side of a support layer of the multilayered acoustic shield, according to a further embodiment of the invention;

FIG. 5 is a perspective view of a second side of the support layer shown in FIG. 4;

FIG. 6 is a cross-sectional view of the support layer shown in FIG. 4, taken along lines A-A of FIG. 4;

FIG. 7 is a perspective view of a first side of a support layer of the multilayered acoustic shield, according to another embodiment of the invention;

FIG. 8 is a perspective view of a second side of the support layer shown in FIG. 7;

FIG. 9 is a cross-sectional view of the support layer shown in FIG. 7 taken along line A-A in FIG. 7;

FIG. 10 is a cross-sectional view of a multilayered acoustic shield having a support layer as shown in FIGS. 7 to 9, according to an embodiment of the invention;

FIG. 11 is an enlarged cross-sectional view of a corner of the multilayered acoustic shield illustrated in FIG. 10; and

FIG. 12 is an enlarged cross-sectional view of a rib of the multilayered acoustic shield illustrated in FIG. 10;

FIG. 13 is a graph showing the absorption coefficient of various sample acoustic shields, having a variety of layers, at a range of frequencies;

FIG. 14 is a graph detailing the transmission loss of various sample acoustic shields, having a variety of layers, at a range of frequency;

FIG. 15 is a graph of the transmission loss of various samples at a range of frequencies;

FIG. 16 is a graph of the absorption coefficient of various samples acoustic shields at a range of frequencies;

FIGS. 17 and 18 are diagrams which illustrate the temperature of various layers of sample acoustic shields when adjacent to an exhaust pipe of approximately 500° C.

### DESCRIPTION OF PREFERRED EMBODIMENTS

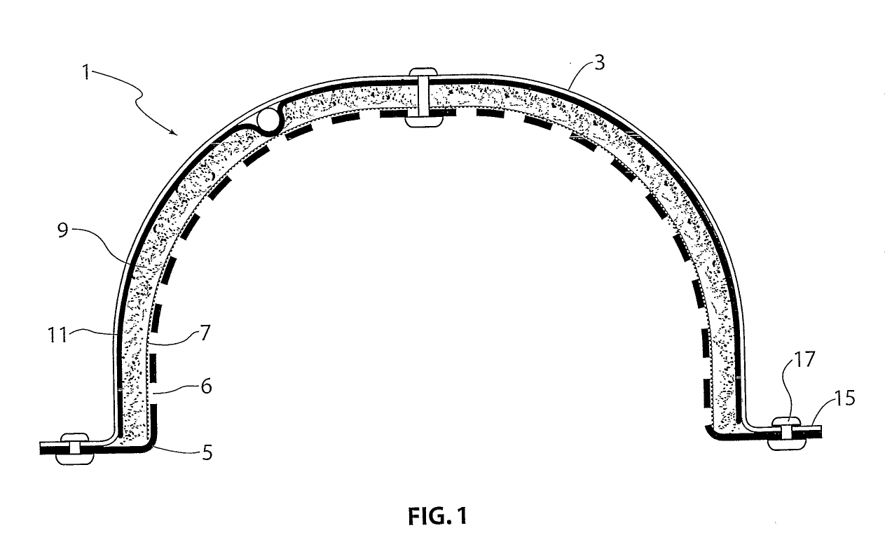

With reference to FIG. 1 of the accompanying drawings there is shown a multilayered acoustic shield 1 mounted to the underside of a transmission tunnel 3 in a vehicle floorpan 15. The shield 1 includes an outer portion and an inner portion. The outer portion includes a support layer 5 having a series of apertures 6. The support layer 5 is preferably made of a sheet of rigid material. The outer portion may also further include a metallic foil 7 which can have perforations therein. The inner portion includes a sound absorbing layer 9 and a vibration dampening layer 11. The support layer 5 is preferably a sheet material that is rigid and made of metal, for example aluminium. The metal preferably has a thickness of between approximately 0.4 mm and 2 mm.

The support layer 5 is the main structural layer of the shield 1 and in part functions to protect the underlying layers from the surrounding environment. For example, the support layer 5 can protect the underlying layers from heat generated by nearby components of the vehicle, such as the catalytic converter. In this regard, the support layer 5 is preferably able to protect the underlying layers such that the temperature of the sound absorbing layer 9 does not exceed approximately 180° C. and the vibration dampening layer 11 does not exceed its melt temperature. As durability of the shield is important, if necessary, the support layer 5 can also be made of two layers of sheet material which are joined together to provide increased strength. This type of construction can also assist the support layer 5 to more appropriately constrain the sound absorbing layer 9 and the vibration dampening layer 11 against the vehicle floorpan 15.

The apertures 6 in the support layer 5 are preferably provided in selected areas and range being between approximately 2.5 mm and 5.0 mm in diameter. The apertures 6 enable sound to more readily penetrate the support layer 5 and subsequently interact with the sound absorbing layer 9 and vibration dampening layer 11. The apertures 6 in the support layer 5 preferably cover no more than approximately 20 to 35 percent of the surface area of the support layer 5 such that the strength of the support layer 5 is maintained.

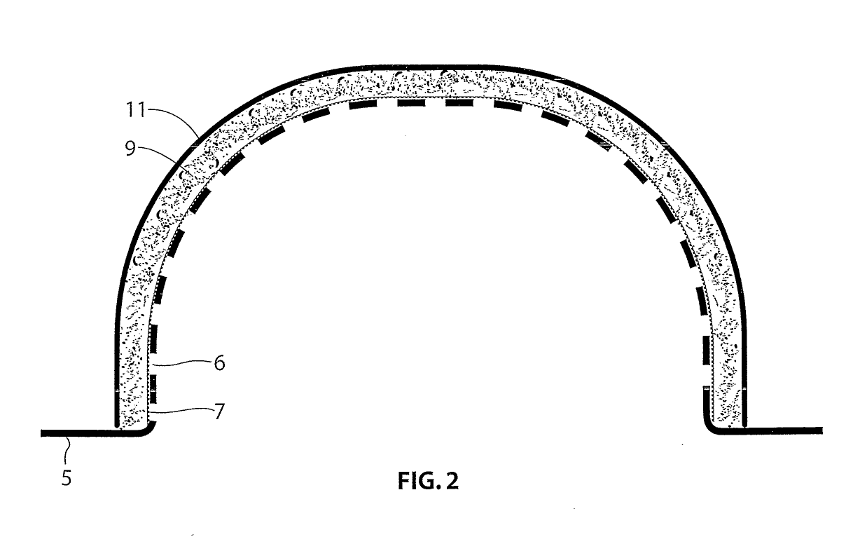

The overall shape of the support layer 5 can be varied to suit specific applications. In the embodiments of the acoustic shield 1 shown in FIGS. 1 to 3 of the drawings, the apertures 6 in the support layer 5 are separated from each other by a surrounding region which is generally planar. As a result the entire surface of one side of the support layer 5 can generally abut with an adjoining layer of the shield 1, as shown in FIGS. 1 to 3. In order to reduce the surface temperature of the support layer 5, and thereby improve the thermal protection provided to the underlying layers, the support layer 5 can also be embossed. This also provides the support layer 5 with additional strength.

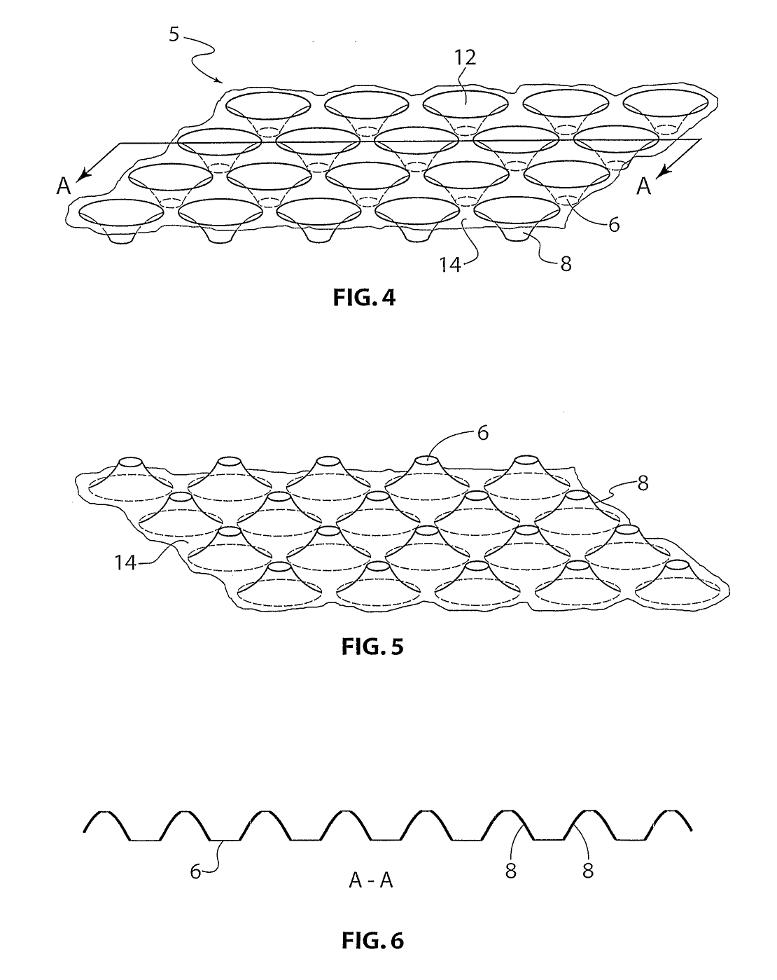

To enhance the support layers 5 ability to direct sound incident on the support layer 5 through the apertures 6 alternative embodiments of the support layer 5, as shown in FIGS. 4 to 9, can be utilised. Like reference numerals are used in all the embodiments to identify the same features. The support layers 5 shown in FIGS. 4 to 6 and FIGS. 7 to 9 both include a plurality of indentations 12 with a multiple number of the indentions 12 each having of an aperture 6 and sidewalls 8 which converge towards their respective aperture 6. The size of the apertures 6 and the depth of the indentations 12 have been magnified in FIGS. 4 to 9, 11 and 12 for clarity. The apertures 6 are preferably circular and have a diameter of between approximately 2.5 mm and 5 mm. The apertures 6 can however be of any other desired shape, for example square, triangular, etc.

The overall thickness of the support layers 5 shown in FIGS. 4 to 6 and FIGS. 7 to 9 range between approximately 3 mm and 5 mm, depending upon the depth of the indentations 12 and the thickness of the metal. In the support layers 5 illustrated in FIGS. 4 to 9, the sidewalls 8 of adjoining indentations 3 converge towards one another and are separated from each other by a surrounding region 14. The surrounding region 14 can be reduced in size by positioning the apertures 6 closer to one another. The surrounding region 14 can be planar, as shown in FIGS. 4 and 5, or alternatively be curved.

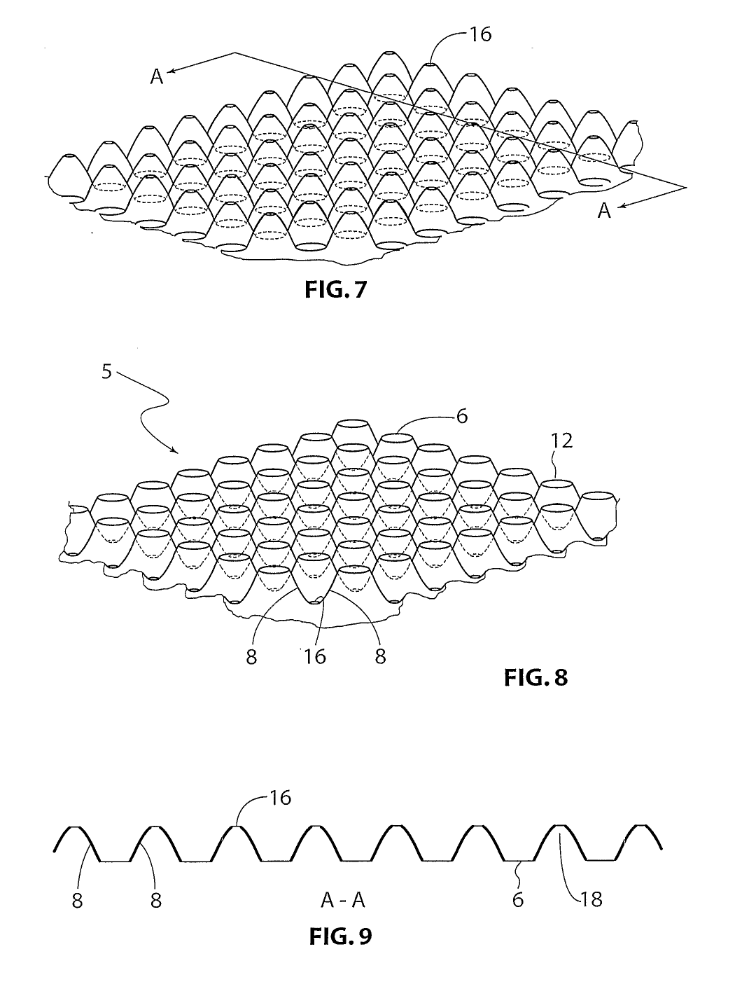

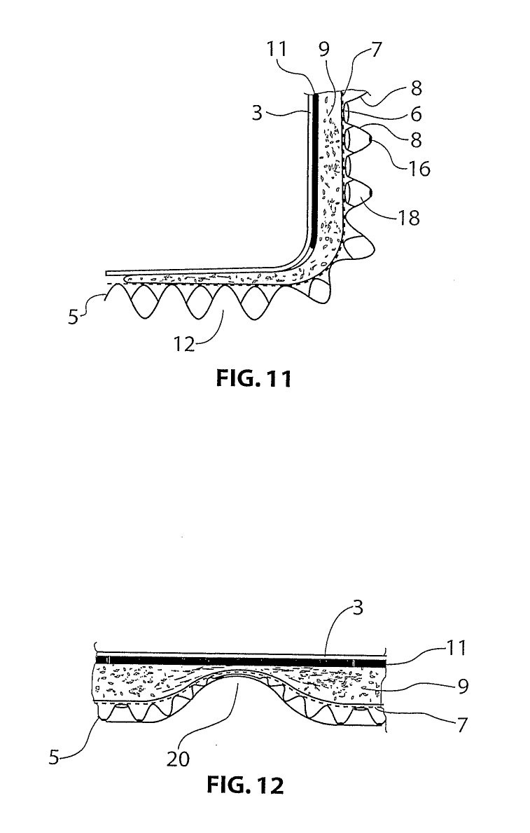

In the support layer 5 illustrated in FIGS. 7 to 9, the sidewalls 8 of adjoining indentations 12 converge towards one another with a perforation 16 being provided at the intersection of the sidewalls 8 of adjoining indentations 12. As shown in FIG. 11, when the support layer 5 is positioned such that the apertures 6 rest on a surface, for example the metallic foil 7 of the acoustic shield 1, a cavity 18 is formed between the sidewalls 8 of adjoining indentations 12 and the metallic foil 7. The perforations 16 provide an opening to each cavity 18 to define each cavity as a Helmholtz resonator. The perforations 16 may range between approximately 0.1 mm and 1.0 mm in diameter and can be formed by piercing the support layer 5 which can also provide each perforation 16 with a neck-like region. When a sound wave interacts with a perforation 16, the air in the neck-like region of the perforation 16 acts like a plug and is pushed into the cavity 18 by the sound wave. Pressure within the cavity 18 then acts like a spring and forces air out of the cavity 18. This causes a slight vacuum in the cavity 18 which results in air being forced back into the cavity 18. The net result of this back and forth motion is that some of the sound waves' energy will be absorbed.

In the accompanying drawings, the apertures 6 are circular and the sidewalls 8 of the indentations 12 form a continuous curved surface around each aperture 6. The sidewalls 8 of the support layer 5 shown in FIGS. 4 and 5 also curve or flare outwardly from the apertures 6 by a considerable amount in comparison with the sidewalls 8 in the support layer 5 shown in FIGS. 7 and 8. The angle of the sidewalls 8 with respect to the aperture 6 and the degree of curvature away from the apertures 6 can be varied to suit each application. In the cross-sectional view of the support layers 5 shown in FIGS. 6 and 9, the sidewalls 8 are generally parabolic with the overall shape of each indentation 12 generally resembling that of a funnel, frustum or truncated cone. The sidewalls 8 of the indentations 12 may however be of any shape which is suitable for guiding sound waves incident on the sidewalls 8 towards and into the apertures 6. For example, the sidewalls 8 could be planar with the overall shape of each indentation 12 resembling a truncated pyramid. It is also possible that a combination of differently shaped indentations 12 could be provided over the support layer 5.

As can be seen from FIGS. 6 and 9, in cross-section the support layer 5 may generally be regarded as having the appearance of a sinusoidal wave with the apertures 6 being provided at the troughs and the sidewalls 8 terminating at the peaks.

The indentations 12 in the support layer 5 shown in the accompanying drawings are arranged in columns and rows. The indentations 12 may alternatively be non-uniformly distributed over the support layer 5. Further, the indentations 12 may be grouped together and only provided over a specific section of the support layer 5. In addition, the sidewalls 8 and apertures 6 in the indentations 12 are able to be formed in a single embossing process. With this process the apertures 6 can be created exactly at the trough of the indentations 12 rather than being randomly positioned as occurs when the apertures are created as a separate process.

The metallic foil 7 is preferably made of aluminium and may range between approximately 0.01 mm and 0.04 mm in thickness. In conjunction with the support layer 5 the metallic foil 7 adds an additional layer of protection to the underlying layers and assists to protect the sound absorbing layer 9 from the ingress of road debris and water. The metallic foil 7 may have a series of micro-perforations to enable sound to more readily penetrate the metallic foil 7 and subsequently interact with the sound absorbing layer 9 and vibration dampening layer 11. The metallic foil 7 can be used where additional protection from radiant heat is required by the sound absorbing layer 9.

The sound absorbing layer 9 can be made of a fibrous material, for example an acoustic grade polyester batt having polyester fibres with a fibre diameter of approximately 2 denier to 10 denier, depending upon the wavelength and frequencies of the sounds which are required to be absorbed. The sound absorbing layer 9 may have a surface density of approximately 800 g/m² and typically ranges between 500 and 1500 g/m². The thickness of the sound absorbing layer 9 is preferably about 5 mm or greater and typically ranges between 5 mm and 15 mm. The fibrous layer of acoustic material is preferably hydrophobic and has fire resistance and/or self extinguishing properties.

In some circumstances it may be appropriate for the sound absorbing layer 9 to have a percentage of polyester co-extrusion melt fibres ranging from 5% to 10% to ensure that an outer surface of the layer 9 can be bonded and made relatively smooth so that fibres do not flake off the layer 9. This ensure that fibres of the sound absorbing layer 9 do not escape through the apertures 6 in the support layer 5 when the metallic foil 7 between the sound absorbing layer 9 and the support layer is not present. Further, in regions of the shield 1 that are subjected to high thermal loads, the overall thickness of the shield 1 can be reduced by bonding the layers and relying on the fibrous layer of acoustic material 9 for thermal insulation only.

The vibration dampening layer 11 can be made of a viscoelastic material. A viscoelastic material is characterised by possessing both viscous and elastic properties. A viscoelastic material will deform under the influence of an applied shear force and when the force is removed the material will recover from some of the deformation. The viscoelastic material is preferably made of a combination of ethylene-vinyl acetate, which is commonly known as EVA, and calcite and may have a thickness between 1.0 mm and 5.0 mm. Further, the viscoelastic material can have a surface density between approximately 1 and 6 kg/m². Alternatively, the viscoelastic material can be made of a bituminous or rubber mix material having appropriate damping properties and a thickness of between about 1.0 mm and 4.0 mm. The vibration dampening layer 11 should also be fire resistant and/or be self extinguishing. Further, the vibration dampening layer 11 can be moulded in a thermal press to conform with a curvature of the transmission tunnel 3 and thereby provide damping to the transmission tunnel 3 when constrained by the other layers of shield 1. The damping can be further improved by the addition of adhesives that add to the frictional relationship between the vibration dampening layer 11 and the floorpan 15. In addition, the vibration dampening layer 11 can be moulded to have one or more grooves 22 for accommodating between the dampening layer 11 and the transmission tunnel 3 cables, air conditioning ducts, pipes, linkages 25 and the like. The vibration dampening layer 11 can improve the transmission loss performance of the shield 1 by more than 10 dB.

In order to tune the acoustic shield 1 to absorb, dampen and reflect specific wavelengths and frequencies of sound, the thickness of each layer can be suitably selected. Further, specific diameters of fibres in the sound absorbing layer 9, perforations/apertures 6 in the support layer 5 and metallic foil 7 can be suitably selected. In addition, the location of the perforations in the support layer 5 and metallic foil 7 can also be suitably selected.

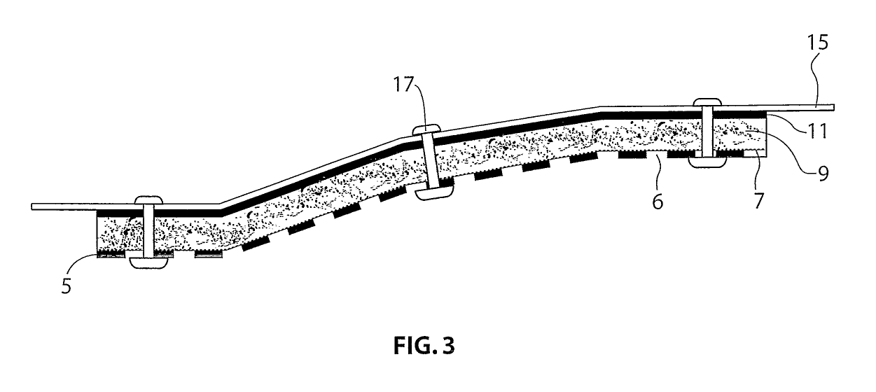

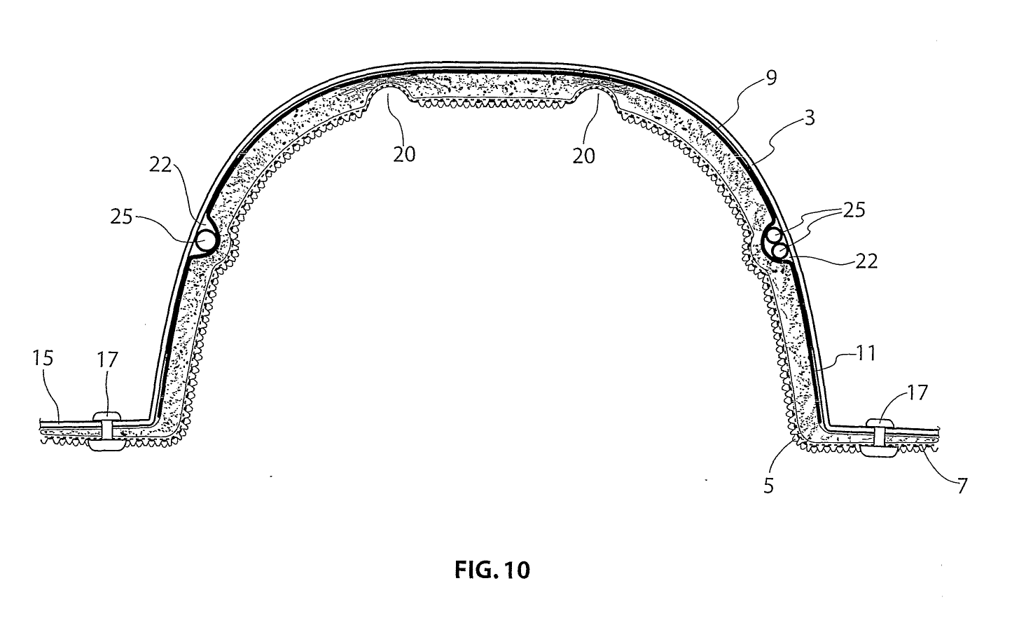

in an embodiment of the invention shown in FIG. 3, the acoustic shield 1 is fastened to the vehicle floorpan 15 at a series of spaced locations across the width of the acoustic shield 1 by fasteners 17. Similarly, in the embodiment of the invention shown in FIG. 1 the acoustic shield 1 is fastened to the transmission tunnel 3 in the vehicle floorpan 15 at a series of locations across the width of the acoustic shield 1 by fasteners 17. However, as three fasteners 17 are not always needed across the width of the shield 1, the acoustic shield 1 can instead be fastened with only two fasteners 17 at opposing sides of the transmission tunnel 3, as shown in FIG. 10. In addition to fastening the acoustic shield 1 to the transmission tunnel 3 the fasteners 17 can assist the support layer 5 to compress the sound absorbing layer 9 against the vibration dampening layer 11. The fasteners 17 may be of any suitable form, for example rivets, studs, nuts, self-tapping screws or the like. The acoustic shield 1 can extend longitudinally along the transmission tunnel 3, directly above the transmission of the vehicle, and may have additional fasteners 17 at spaced locations along the length of the acoustic shield 1.

Preferably, the support layer 5 has some degree of flexibility. This advantageously enables the acoustic shield 1 to maintain conformance with the curvature of the underside of the transmission tunnel 3 and compress the sound-absorbing layer 9 against the vibration dampening layer 13. Further, the vibration dampening layer 11 is advantageously maintained in firm contact with the curvature of the underside of the transmission tunnel 3 such that optimal dampening of sound waves propagating through the transmission tunnel 3 can be achieved. In addition, the compression of the sound absorbing layer 9 ensures that the shield 1 is of a minimal thickness. As shown in FIGS. 10 and 12, selected sections of the acoustic shield 1 can also be compressed to create strengthening ribs 20 which may extend longitudinally of the shield 1. The strengthening ribs 20 are created primarily by the compression of the sound absorbing layer 9 following the application of heat. The compression of the sound absorbing layer 9 enables added compressive force to be applied by the support layer 5 on the vibration dampening layer 11.

FIG. 11 is a cross-sectional view of a corner of the multilayered acoustic shield 1 illustrated in FIG. 10. The vibration dampening layer 11 terminates within the transmission tunnel region prior to the corner such that it is easier to conform the shield 1 with the contour of the floorpan 15. As can be seen in FIG. 11, the apertures 6 can be positioned in close proximity to the metallic foil 7 such that sound waves incident on the sidewalls 8 of the indentations 12 in the support layer 5 are able to be guided through the apertures 6 by reflection off the sidewalls 8 such that sound waves are thereby directed to the metallic foil 7.

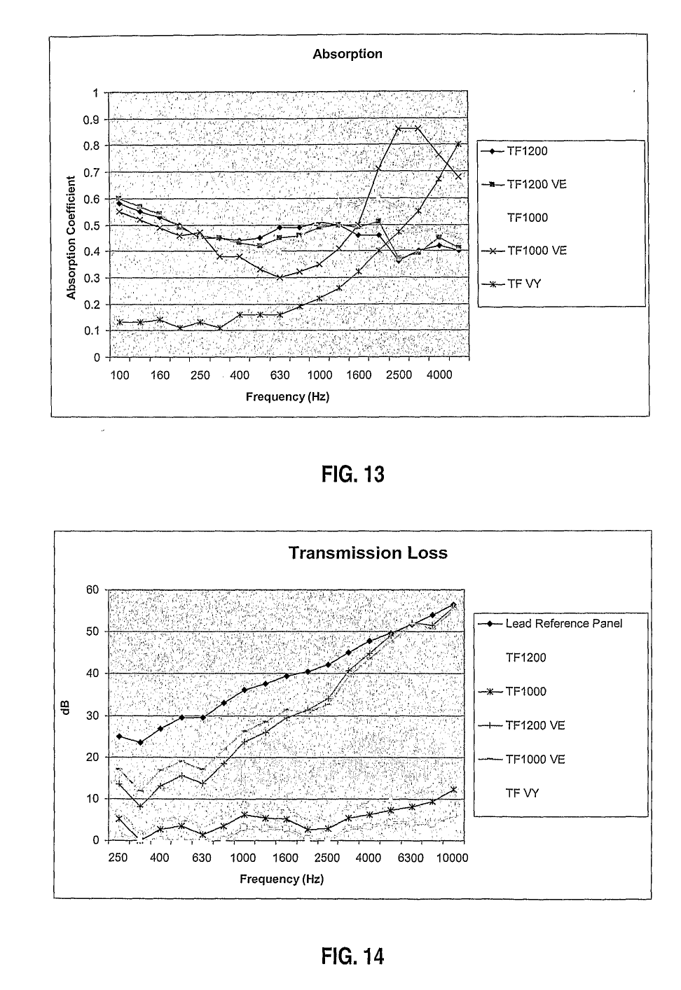

Similar to the vibration dampening layer 13, the apertures 6 in the support layer 5 may terminate in the transmission tunnel region. Further, in areas which are subjected to high thermal loads the apertures 6 can be omitted from selected sections of the support layer 5, as shown in FIG. 11. The graph in FIG. 13 shows the absorption coefficient of various acoustic shield samples at a range of frequencies. With the exception of the sample identified in FIG. 13 as TF VY, alt of the samples in FIG. 13 consist of an outer portion having a support layer 5 and a metallic foil 5. The support layer 5 has indentations and apertures similar to the support layer illustrated in FIGS. 7 to 9. The apertures cover approximately 25% of the surface area of the support layer and the support layer is made of aluminium having a thickness of 0.5 mm. The apertures in the support layer are approximately 4 mm in diameter. The samples identified as TF1000 and TF1200 also include a sound absorbing layer 9 having a surface density of 1000 g/m² and 1200 g/m² respectively. The sample identified as TF1000 VE is similar to TF1000 except TF1000 VE also includes a vibration damping layer 11 made of a viscoelastic material having a surface density of 4 kg/m². Similarly, the sample identified at TF1200 VE is the same as TF1200 except sample TF1200 VE also includes a vibration damping layer made of viscoelastic material having a surface density of 4 k/m². The final sample identified in the graph as TF VY is a compressed layer of sound absorbing material having a surface density of 1000 g/m². The graph in FIG. 13 demonstrates that the apertures and indentations in the support layer enable the shields to have absorption levels far greater than would normally be expected for apertures of this size. Further, the samples having the support layer and microfoil all performed far better than the sample consisting only of sound absorbing material, namely TF VY. The graph shown in FIG. 13 also demonstrates that the two shields having a sound absorption layer with a surface density of 1200 g/m² generally performed better than those with a surface density of 1000 g/m², particularly below 1500 hertz.

The graph in FIG. 14 shows the transmission loss of the samples referred to in FIG. 13, at a range of frequencies. The graph also shows the transmission loss of a lead reference panel at various frequencies. As can be seen from the graph the lead reference panel provides the greatest transmission loss across all frequencies, as would be expected. The graph also demonstrates that the two shields having a support layer, metallic foil layer, sound absorbing layer and vibration damping layer, performed far better than those samples which did not include a vibration damping layer.

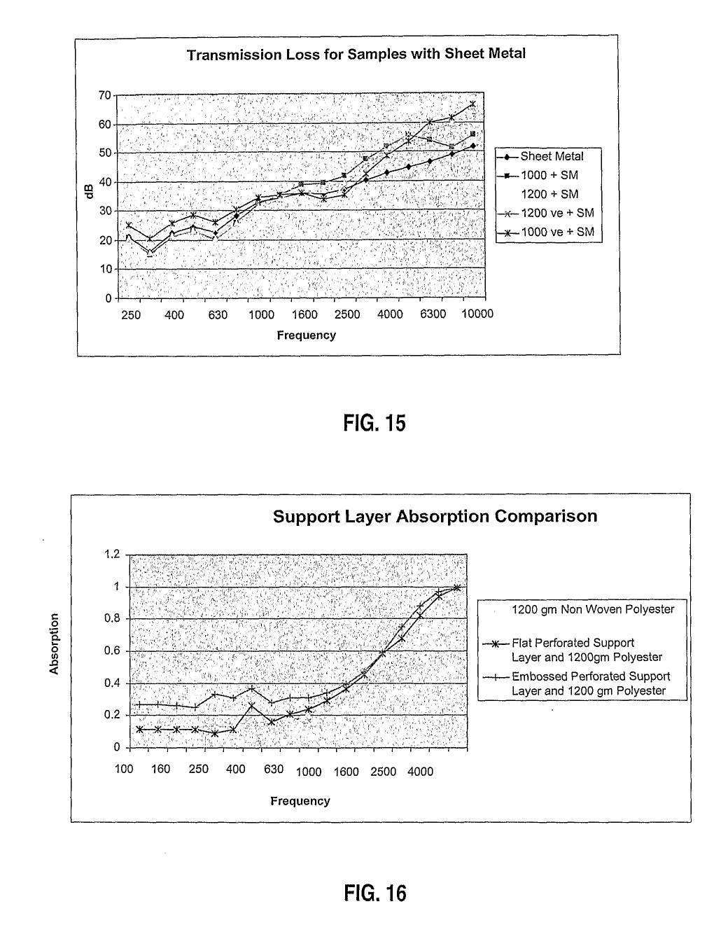

The graph in FIG. 15 also shows the transmission loss of various samples at a range of frequencies. The first sample identified in the graph as “sheet metal” has a thickness of 1 mm. This sample is representative of a panel to which the acoustic shield could be mounted. The second sample, identified in the graph as 1000+SM, is a layer of sound absorbing material having a surface density of 1000 g/m² in combination with the sheet metal. Similarly, the sample identified as 1200+SM, is a sound absorbing layer having a surface density of 1200 g/m² in combination with the sheet metal. The sample identified as 1200 ve+SM is similar to the 1200+SM sample except this sample also has a vibration dampening layer comprising viscoelastic material having a surface density of 4 kg/m². The sample identified as 1000 ve+SM is similar to sample 1000+SM except this sample also has a vibration dampening layer consisting of viscoelastic material having surface density of 4 kg/m². The graph demonstrates that if the results for the sheet metal are considered to be the base line, then the two samples which have the vibration dampening layer perform considerably better than the other two remaining layers, particularly at lower frequencies. The graph in FIG. 15 also shows that at frequencies of 315 hertz, 630 hertz and approximately 2000 hertz the transmission loss performance of the various samples shields deteriorates somewhat. The reason for this was that the natural frequencies of the samples, which measured 450 mm by 450 mm, was reached. The samples therefore began vibrating which added to the sound being transmitted through each sample.

The graph shown in FIG. 16 also shows the absorption coefficient of various samples and a range of frequencies. The first sample is a non woven polyester sound absorbing layer having a surface density of 1200 g/m². The second sample is a planar support layer, similar to that depicted in FIGS. 1 to 3, in combination with the polyester sound absorbing layer of sample one. The support layer consists of a sheet of aluminium with a thickness of 0.5 mm. The sheet has a plurality of apertures each having a diameter of 3 mm. The apertures provide the sheet with an open area of 33%. The third sample is an indented or embossed support layer, similar to that depicted in FIGS. 4 to 9, in combination with the polyester sound-absorbing layer of sample 1. The sheet material of the third sample is aluminium with a thickness of 0.5 mm and has indentations which make the overall thickness of the support layer 3 mm. Each indentation has sidewalls which converge towards a circular aperture of 3 mm in diameter. Each indentation has a diameter of 5 mm which reduces to 3 mm at the aperture. The graph in FIG. 16 shows that a greater proportion of sound is absorbed by the third sample i.e. the indented support layer in combination with the polyester sound absorbing layer, particularly at frequencies below 1000 hertz.

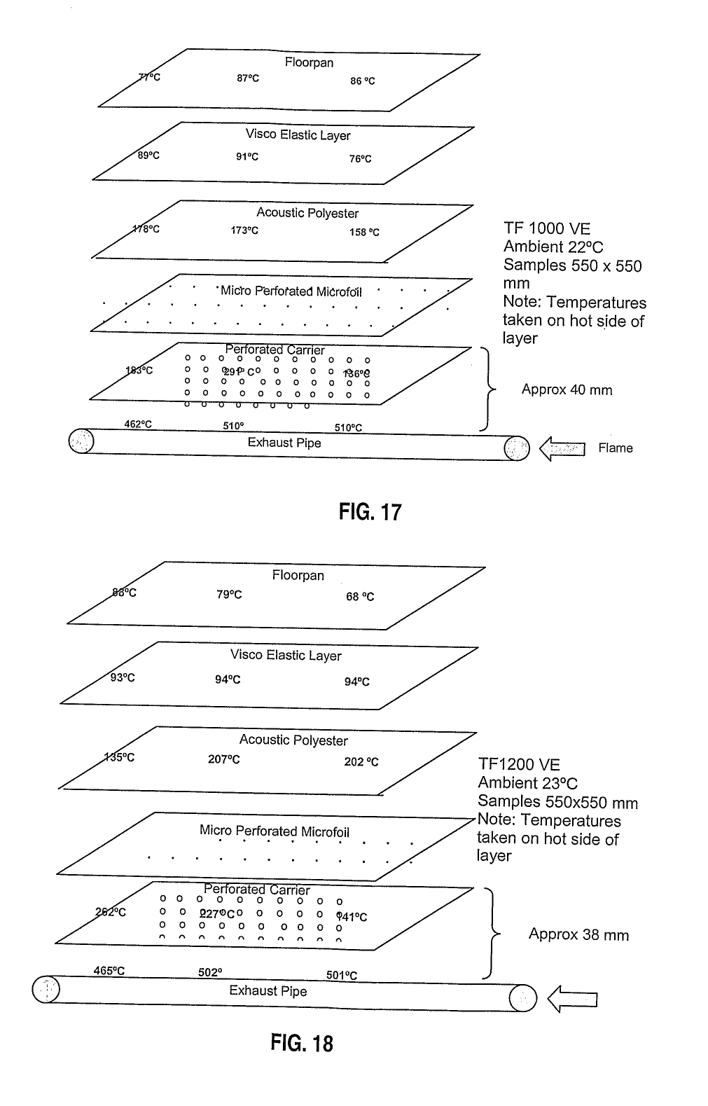

The diagrams illustrated in FIGS. 17 and 18 demonstrate the temperature of various layers of sample acoustic shields when positioned near a heat source of approximately 500° C. The acoustic shield shown in FIG. 17 has a sound absorbing layer consisting of polyester having a surface density of 1000 g/m². The support layer of the acoustic shield is positioned approximately 40 mm from an exhaust pipe. The diagram demonstrates that the surface temperature of the floorpan 15 on the side facing the exhaust pipe was maintained at a temperature of approximately 80° C.

The acoustic shield illustrated in FIG. 18 is similar to that depicted in FIG. 17 except the sound absorbing layer in FIG. 18 has a surface density of 1200 g/m². As can be seen from the diagram, the floorpan 15 of the vehicle was maintained at a temperature of approximately 70° C. The diagrams shown in FIGS. 17 and 18 demonstrate that the vibration dampening layer, namely the viscoelastic layer and the floorpan 15 can be adequately protected from thermal radiation emitted by nearby heat sources by the acoustic shield of the present invention.

The support layer 5, sound absorbing layer 9 and vibration dampening layer 11 of the present invention advantageously interact to trap sound within the shield 1 by absorption and block sound from passing through the shield 1. In this regard, the vibration dampening layer 11 not only blocks sound being transmitted through the shield 1, but also dampens any vibrations when the shield is placed in abutment with a panel, for example a vehicle floorpan 15.

Further, the support layer 5 advantageously allows sound waves propagating through the air to pass through the support layer 5 into engagement with the underlying layers whilst at the same time protect underlying layers of the shield 1 from excessive heat and the surrounding environment. Similarly, the perforations in the metallic foil 7 enable sound waves propagating through the air to pass through the metallic foil 7 such that they can subsequently interact with the sound absorbing layer 9 and vibration dampening layer 11. The metallic foil 7 enables the shield 1 to have a higher thermal rating whilst maintaining the acoustic performance of the shield 1. The metallic foil 7 also advantageously acts as a membrane coupling for sound transfer into the sound absorbing layer 9. The support layer 5, in combination with the metallic foil 7 if necessary, functions to protect the underlying layers from excessive heat, debris, dirt, water and the like. In addition, the support layer 5 can have a level of flexibility which enables the shield 1 to maintain the vibration dampening layer 11 in firm contact with the transmission tunnel 3.

Vibration dampening materials such as viscoelastic material typically have a low melting point. This advantageously enables the dampening layer 11 to be suitably moulded to conform with the curvature of the transmission tunnel 3. However, this also means that the vibration dampening layer 13 needs to be thermally protected from nearby heat sources, such as the exhaust system. In this regard, the support layer 5, in combination with the metallic foil 7 if necessary, and sound absorbing layer 9 provide adequate thermal protection to the dampening layer 15. The sound absorbing layer 9 also advantageously functions to dampen the support layer 5, thereby reducing the reflection of sound off the support layer 5 into the surrounding environment.

The shield 1 according to the present invention advantageously enables optimal reduction in the transmission of noise into a cabin of a vehicle primarily due to the combination of the sound absorbing layer 9 and vibration dampening layer 11. In this regard, the vibration dampening layers 11 direct contact with the transmission tunnel 3 of the vehicle floorpan 15 enables vibrational energy of sound waves propagating through the transmission tunnel 3 and floorpan 15 to be dampened, thereby reducing the transmission of sound into the cabin of the vehicle. In addition, the vibration dampening layer 11 assists the sound absorbing layer 9 to absorb airborne sound waves propagating within the sound absorbing layer 9 by reflecting some of the airborne sound waves, which impact with an outer surface of the vibration dampening layer 11, back into the sound absorbing layer 9. Accordingly, the mechanical or vibration energy of these reflected airborne sound waves can be further reduced due to the converting of the energy into thermal energy due to friction within the sound absorbing layer 9. Further, the vibration dampening layer 11 is able to absorb some of the airborne sound waves, which impact on the outer surface, as mechanical energy.

In addition, the strength of the support layer 5 enables the shield 1 to be forcibly compressed against the floorpan 15 such the vibration dampening layer 11 and sound absorbing layer 9 are constrained. The constraining affect derived from the force supplied by the support layer 5 enables a lesser quantity of viscoelastic material to be need for the vibration dampening layer 11 to achieve the same level of dampening as an unconstrained layer.

Further, by providing the support layer 5 with indentations 12 which incorporate apertures 6 the sidewalls 8 of the indentations 12 are able to further enhance the transmission of sound to the underlying layers of the acoustic shield 1 by diverting the focusing sound waves incident on the sidewalls 8 towards the apertures 6. Accordingly, the number and diameter of the apertures 6 can be reduced if needed without a corresponding reduction in the acoustic performance of the shield 1 being made. In addition, as the sidewalls 8 and apertures 6 in the indentations 12 are able to be formed in a single embossing process the apertures 6 can advantageously be created exactly at the trough of the indentations 12 rather than being randomly positioned as occurs when the apertures are created as a separate process to the embossing of indentations.

As the present invention may be embodied in several forms without departing from the essential characteristics of the invention, it should be understood that the above described embodiments should not be considered to limit the present invention but rather should be construed broadly. Various modifications and equivalent arrangements are intended to be included within the spirit and scope of the invention. Whilst the invention has been described in relation to its use in vehicles it should not be considered as limiting the invention to only that example application. In this regard, the invention is also intended to be suitable for buildings, aeroplanes, vacuum cleaners, washing machines, industrial machinery, generators, refrigerators, photocopy machines and the like.

1. A multilayered acoustic shield for mounting to a panel of a vehicle, the shield including an outer portion and an inner portion, the outer portion including a support layer having apertures therein, the inner portion including a sound-absorbing layer and a vibration-dampening layer, wherein the shield is fastenable to the panel of the vehicle such that at least a portion of the dampening layer engages the panel with the sound-absorbing layer being compressed between the outer portion and the dampening layer, to thereby reduce the transmission of noise into a cabin of the vehicle.

2. A multilayered acoustic shield as claimed in claim 1 wherein the outer portion further includes a metallic foil located between the support layer and the sound-absorbing layer.

3. A multilayered acoustic shield as claimed in claim 1 wherein the dampening layer is made of a viscoelastic material.

4. A multilayered acoustic shield as claimed in claim 3 wherein the dampening layer is moulded to conform with a curvature of the panel.

5. A multilayered acoustic shield as claimed in claim 2 wherein the support layer includes a plurality of indentations therein.

6. A multilayered acoustic shield as claimed in claim 5 wherein at least one of the indentations includes an aperture therein and sidewalls which converge towards the aperture.

7. A multilayered acoustic shield as claimed in claim 6 wherein the sidewalls provide a continuous curved surface extending around the aperture.

8. A multilayered acoustic shield as claimed in claim 5 wherein a multiple number of the indentations each include an aperture and sidewalls which converge towards their respective aperture.

9. A multilayered acoustic shield as claimed in claim 8 wherein in use a multiple number of the apertures abut with an adjoining layer of the acoustic shield to thereby guide sound waves incident on the sidewalls through the apertures towards the adjoining layer.

10. A multilayered acoustic shield as claimed in claim 8 wherein the sidewalls of adjoining indentations converge towards one another.

11. A multilayered acoustic shield as claimed in claim 10 wherein a cavity is formed between the sidewalls of adjoining indentations and the adjoining layer of the acoustic shield.

12. (canceled)

13. A multilayered acoustic shield as claimed in claim 9 wherein the adjoining layer is the metallic foil.

14. A multilayered acoustic shield as claimed in claim 9 wherein the adjoining layer is the sound-absorbing layer.

15. A multilayered acoustic shield as claimed in claim 1 wherein the support layer is a sheet of rigid material.

16. A multilayered acoustic shield as claimed in claim 2 wherein the metallic foil has perforations therein.

17. A multilayered acoustic shield for mounting to an underside of a transmission tunnel in a vehicle floorpan, the shield including an outer portion and an inner portion, the outer portion including a support layer having apertures therein, the inner portion including a sound-absorbing layer and a vibration-dampening layer, wherein the shield is fastenable to the vehicle floorpan such that at least a portion of the dampening layer engages with the underside of the transmission tunnel with the sound-absorbing layer being compressed between the outer portion and the dampening layer, to thereby reduce the transmission of noise into a cabin of the vehicle.

18. A multilayered acoustic shield as claimed in claim 17 wherein the outer portion further includes a metallic foil located between the support layer and the sound-absorbing layer.

19. A multilayered acoustic shield as claimed in claim 17 wherein the dampening layer is made of a viscoelastic material.

20. A multilayered acoustic shield as claimed in claim 19 wherein the dampening layer is moulded to conform with a curvature of the transmission tunnel.

21. A multilayered acoustic shield as claimed in claim 18 wherein the support layer includes a plurality of indentations therein.

22. A multilayered acoustic shield as claimed in claim 21 wherein at least one of the indentations includes an aperture therein and sidewalls which converge towards the aperture.

23. A multilayered acoustic shield as claimed in claim 22 wherein the sidewalls provide a continuous curved surface extending around the aperture.

24. A multilayered acoustic shield as claimed in claim 21 wherein a multiple number of the indentations each include an aperture and sidewalls which converge towards their respective aperture.

25. A multilayered acoustic shield as claimed in claim 24 wherein in use a multiple number of the apertures abut with an adjoining layer of the acoustic shield to thereby guide sound waves incident on the sidewalls through the apertures towards the adjoining layer.

26. A multilayered acoustic shield as claimed in claim 24 wherein the sidewalls of adjoining indentations converge towards one another.

27. A multilayered acoustic shield as claimed in claim 26 wherein a cavity is formed between the sidewalls of adjoining indentations and the adjoining layer of the acoustic shield.

28. (canceled)

29. A multilayered acoustic shield as claimed in claim 25 wherein the adjoining layer is the metallic foil.

30. A multilayered acoustic shield as claimed in claim 25 wherein the adjoining layer is the sound-absorbing layer.

31. (canceled)

32. A multilayered acoustic shield as claimed in claim 18 wherein the metallic foil has perforations therein.

33. (canceled)
